(19) United States
(12) Patent Application Publication
(10) Pub. No.: US 2014/0290839 A1
(43) Pub. Date: Oct. 2, 2014

(54) TRANSFER APPARATUS AND TRANSFER METHOD

(71) Applicant: DAINIPPON SCREEN MFG. CO., LTD., Kyoto (JP)

(72) Inventors: Yayoi SHIBAFUJI, Kyoto (JP); Masafumi KAWAGOE, Kyoto (JP); Mikio MASUICHI, Kyoto (JP); Hiroyuki UENO, Kyoto (JP); Kazuhiro SHOJI, Kyoto (JP); Miyoshi UENO, Kyoto (JP)

(73) Assignee: DAINIPPON SCREEN MFG. CO., LTD., Kyoto (JP)

(21) Appl. No.: 14/219,135

(22) Filed: Mar. 19, 2014

(30) Foreign Application Priority Data
Mar. 28, 2013 (JP) 2013-067899

(51) Int. Cl. B32B 37/00

(52) U.S. Cl. CPC B32B 37/0053
USPC 156/230; 156/540

(57) ABSTRACT

A transfer apparatus includes a plurality of holders respectively coming into contact with a carrier and a roller member. Each of the holders is sequentially separated from the carrier in accordance with a movement of the roller member, moves to a retracted position where the holder does not interfere with the roller member, comes into contact with the other surface of the carrier again after the passage of the roller member, and moves in the direction away from the carrier while sucking the carrier by the suction unit.

### CROSS REFERENCE TO RELATED APPLICATION

The disclosure of Japanese Patent Application No. 2013-67899 filed on Mar. 28, 2013 including specification, drawings and claims is incorporated herein by reference in its entirety.

### BACKGROUND OF THE INVENTION

1. Field of the Invention

The invention relates to a transfer apparatus and a transfer method for transferring a transfer object carried on a carrier to a transfer medium.

2. Description of the Related Art

A technology for bringing a carrier carrying a pattern or the like into close contact with a transfer medium to transfer the pattern or the like is known as a technology for forming a thin film or a pattern (hereinafter, referred to as a “pattern or the like”) on a substrate such as a glass substrate or a semiconductor substrate (see, for example, JP2002-036499A). Further, to complete the transfer of the pattern or the like, the carrier and the transfer medium brought into close contact as described above need to be detached and separated again. A technology aimed at such detachment is disclosed, for example, in JP2008-287949A.

As indicated by the above conventional technologies, a process technology for transferring a pattern or the like by bringing a carrier and a transfer medium into close contact and a process technology for detaching a carrier and a transfer medium after the transfer have been studied independently of each other thus far.

In an actual pattern forming process, both a transfer process and a detachment process are essential as a matter of course. However, in the case of performing the transfer process and the detachment process in different processing apparatuses as described above, a processing object needs to be conveyed between the processing apparatuses. Furthermore, the other apparatus is in a standby state while the process is performed in one processing apparatus. Thus far, a series of processes from the transfer to the detachment have not been able to be efficiently performed. Further, since two processing apparatuses need to be installed, there also remains a problem of increasing apparatus cost and an installation space.

### SUMMARY OF THE INVENTION

The present invention was developed in view of the above problems and an object thereof is to provide a technology capable of successively and efficiently performing the transfer of a transfer object from a carrier to a transfer medium and the detachment of the carrier and the transfer medium after the transfer.

To achieve the above object, a transfer apparatus according to the present invention includes: a carrier holder that includes a plurality of holders and is configured to hold a plate-like carrier having a carrying surface, on which a transfer object is carried, by the holders respectively coming into contact with the other surface of the carrier opposite to the carrying surface; a holder driving mechanism that individually moves the holders in directions toward and away from the other surface; a transfer medium holder that holds a transfer medium having a transfer surface, to which the transfer object is to be transferred, such that the transfer surface proximately faces the carrying surface; and a roller member that has a roller shape whose axial direction is a first direction parallel to the carrying surface and is configured to move in a second direction parallel to the carrying surface and perpendicular to the first direction while bringing the transfer object into contact with the transfer surface by coming into contact with the other surface and partially displacing the carrier toward the transfer medium, wherein the holders, each of which includes a suction unit for sucking the other surface, are arranged along the second direction, and each of the holders is sequentially separated from the carrier in accordance with a movement of the roller member, moves to a retracted position where the holder does not interfere with the roller member, comes into contact with the other surface of the carrier again after the passage of the roller member, and moves in the direction away from the carrier while sucking the carrier by the suction unit.

Further, to achieve the above object, a transfer method according to the present invention includes: a first step of holding a plate-like carrier having a carrying surface, on which a transfer object is carried, by respectively bringing a plurality of holders into contact with the other surface of the carrier opposite to the carrying surface; a second step of holding a transfer medium having a transfer surface, to which the transfer object is to be transferred, such that the transfer surface proximately faces the carrying surface; a third step of bringing the transfer object into contact with the transfer surface by bringing a roller member having a roller shape whose axial direction is a first direction parallel to the carrying surface into contact with the other surface to partially displace the carrier toward the transfer medium; a fourth step of moving the roller member in a second direction parallel to the carrying surface and perpendicular to the first direction while bringing the roller member into contact with the other surface, sequentially separating the holders from the carrier and moving the holders to a retracted position where the holders do not interfere with the roller member in accordance with a movement of the roller member, and bringing the holders into contact with the other surface of the carrier again after the passage of the roller member; and a fifth step of moving the holder in the direction away from the carrier while holding the carrier by the holders held in contact with the other surface.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a schematic configuration diagram of a transfer apparatus according to one embodiment of the present invention;

FIG. 2 is a view showing a main part of the transfer apparatus of FIG. 1;

FIGS. 3A to 3C are enlarged views showing the structure of a hand tip in detail;

FIG. 4 is a flow chart showing the transfer process in the embodiment;

FIGS. 5A to 5C, 6A to 6C and 7A to 7C are views diagrammatically showing a positional relationship of each component of the apparatus in each stage of the transfer process; and

FIGS. 8A and 8B are views showing other configuration examples of the transfer apparatus according to the present invention.

### DETAILED DESCRIPTION OF THE PREFERRED EMBODIMENTS

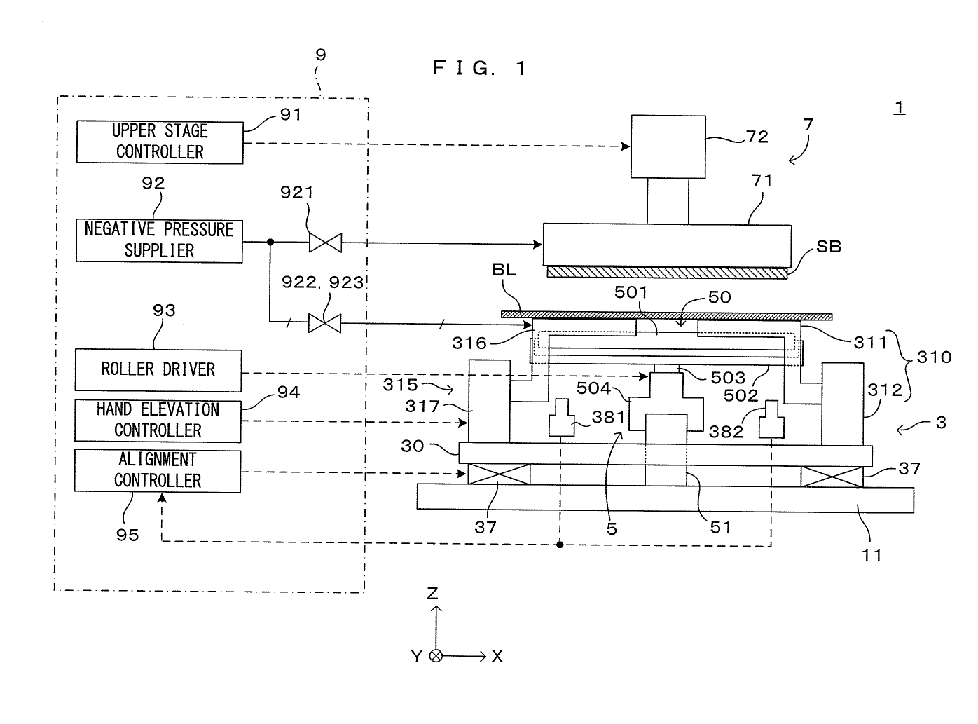

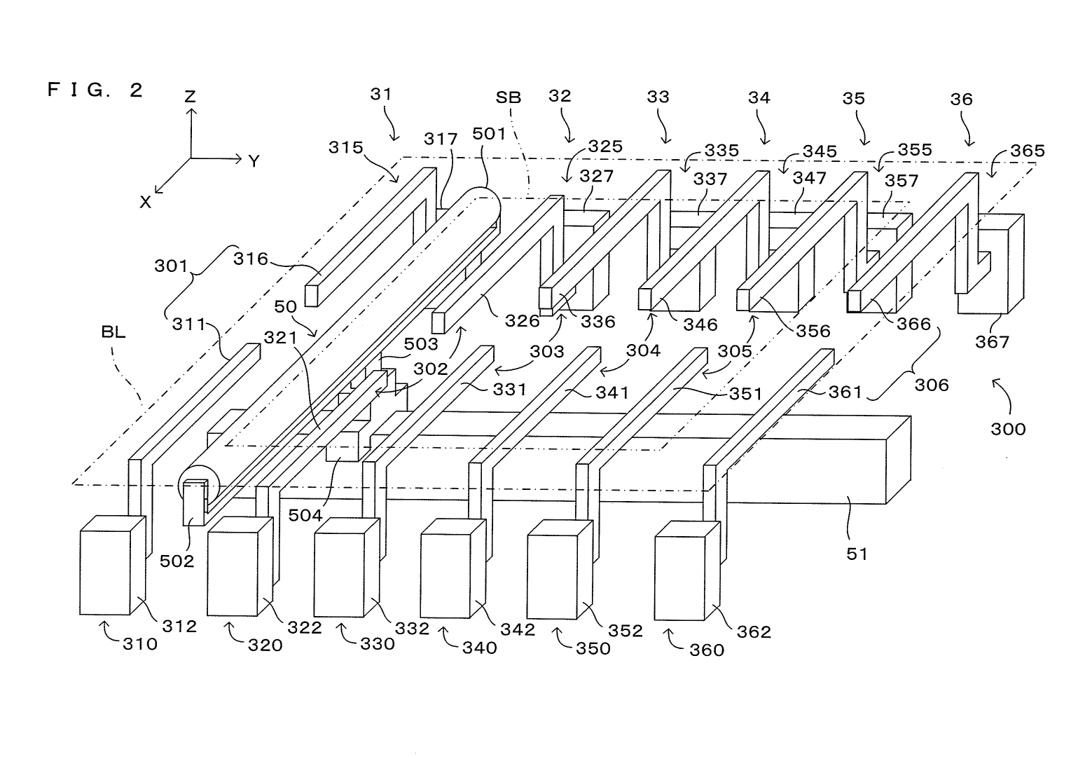

FIG. 1 is a schematic configuration diagram of a transfer apparatus according to one embodiment of the present invention. FIG. 2 is a view showing a main part of the transfer apparatus of FIG. 1. XYZ orthogonal coordinate axes are set as shown in FIG. 1 to show directions in each of the following figures in a unified manner. Here, an XY plane represents a horizontal plane and a Z axis represents a vertical axis. More specifically, a (+Z) direction represents a vertically upward direction.

The transfer apparatus 1 is an apparatus for bringing two plate-like bodies in a state separated from each other into close contact and then separating them again later, and is used, for example, in a part of a pattern forming process for forming a predetermined pattern on a surface of a substrate such as a glass substrate or a semiconductor substrate. More specifically, in the pattern forming process, a pattern forming material is uniformly coated on a surface of a blanket as a carrier for temporarily carrying a pattern to be transferred to the substrate as a transfer object (coating step). A plate surface-processed in accordance with a pattern shape is pressed against a coating layer on the blanket to pattern the coating layer (patterning step). The blanket formed with the pattern in this way is brought into close contact with the substrate (transferring step), whereby the pattern is finally transferred from the blanket to the substrate.

The patterning step includes a process for detaching the plate and the blanket after the plate and the blanket are brought into close contact, while the transferring step includes a process for detaching the substrate and the blanket after the substrate and the blanket are brought into close contact. For these purposes, the apparatus can be suitably applied. Of course, this apparatus may be used in both of these processes or may be used for another application. For example, the apparatus can also be applied, for example, to a transfer process for transferring a thin film carried on a carrier to a substrate.

The following description will be made on the premise that the transfer apparatus 1 is used in the above transferring step, i.e. in the process for transferring the pattern formed on the blanket to the substrate. However, the configuration and operation of the apparatus are basically the same also in the case of application to the patterning step, and the “substrate” in the following description may be replaced by the “plate”.

The transfer apparatus 1 includes a blanket holding block 3 mounted on a base unit 11 attached to a housing and configured to hold a blanket BL, a transfer roller block 5 mounted on the base unit 11, and a substrate holding block 7 arranged above the blocks 3 and 5 and configured to hold a substrate SB. In FIG. 1, the housing is not shown to show an internal structure of the apparatus. Further, the transfer apparatus 1 includes a control block 9 for controlling each block in addition to these respective blocks.

The blanket holding block 3 is so structured that a plurality of elevation hand units are arranged in an X direction and a Y direction on an alignment stage 30. More specifically, a plurality of (six in this example) elevation hand units 310, 320, 330, 340, 350 and 360 are arranged in the Y direction along a (+X) side end part of the alignment stage 30. Further, as many elevation hand units 315, 325, 335, 345, 355 and 365 as these are arranged along a (−X) side end part of the alignment stage 30.

Each elevation hand unit has the same structure. For example, the elevation hand unit 310 includes a hand 311 whose upper part extends in the horizontal direction (X direction) and whose upper surface comes into contact with the lower surface of the blanket BL to support the blanket BL from below, and a hand elevation mechanism 312 for supporting the hand 311 and elevating and lowering the hand 311 in the vertical direction (Z direction). The hand elevation mechanism 312 elevates and lowers the hand 311 in response to a control signal from a hand elevation controller 94 provided in the control block 9.

The other elevation hand units are similarly structured. Here, hands provided in the elevation hand units 315, 320, 325, 330, 335, 340, 345, 350, 355, 360 and 365 are respectively denoted by 316, 321, 326, 331, 336, 341, 346, 351, 356, 361 and 366. Further, hand elevation mechanisms provided in the elevation hand units 315, 320, 325, 330, 335, 340, 345, 350, 355, 360 and 365 are respectively denoted by 317, 322, 327, 332, 337, 342, 347, 352, 357, 362 and 367.

The elevation hand units 310, 320, 330, 340, 350 and 360 arranged on the (+X) side end part of the alignment stage 30 are respectively so arranged that the tips of the hands face a (−X) side. On the other hand, the elevation hand units 315, 325, 335, 345, 355 and 365 arranged on the (−X) side end part of the alignment stage 30 are respectively so arranged that the tips of the hands face a (+X) side. Specifically, the elevation hand units arranged on the (+X) side end part and those arranged on the (−X) side end part are so arranged that the inward facing hands thereof face each other.

The elevation hand units 310, 315 arranged farthest on a (−Y) side on the (+X) side end part and (−X) side end part of the alignment stage 30 are arranged at the same position in the Y direction. Accordingly, the hand 311 of the elevation hand unit 310 and the hand 316 of the elevation hand unit 315 are located at the same position in the Y direction. Further, these hands 311, 316 are constantly positioned at the same height position (Z-direction position) and integrally elevated and lowered by a control signal from the hand elevation controller 94. Specifically, a pair of elevation hand units 310, 315 located at the same position in the Y direction form a hand unit pair (first hand unit pair) 31.

Similarly, the elevation hand units 320, 325 located at the same position in the Y direction form a second hand unit pair 32, the elevation hand units 330, 335 form a third hand unit pair 33, the elevation hand units 340, 345 form a fourth hand unit pair 34, the elevation hand units 350, 355 form a fifth hand unit pair 35, and the elevation hand units 360, 365 form a sixth hand unit pair 36.

By positioning the hands 311, 316, 321; 326, 331, 336, 341, 346, 351, 356, 361 and 366 provided in the respective elevation hand units 310, 315, 320, 325, 330, 335, 340, 345, 350, 355, 360 and 365 at the same height, these hands 311, 316, 321, 326, 331, 336, 341, 346, 351, 356, 361 and 366 can integrally hold the blanket BL in a horizontal posture. Note that a pair of hands included in each hand unit pair (e.g. a pair of hands 311, 316 in the hand unit pair 31) are constantly at the same height, whereas the hand elevation controller 94 can independently control the height of the included hands among the different hand unit pairs. A state where the hands 321, 326 of the second hand unit pair 32 are at a lower position than the other hands is shown as an example in FIG. 2.

In the following description, a pair of hands included in the N^{th} hand unit pair (N=1 to 6) is referred to as the “N^{th} hand pair.” Specifically, the pair of hands 311, 316 included in the first hand unit pair 31 is referred to as a “first hand pair” and denoted by 301. Similarly, the pair of hands 321, 326 included in the second hand unit pair 32 is referred to as a second hand pair 302; the pair of hands 331, 336 included in the third hand unit pair 33 as a third hand pair 303; the pair of hands 341, 346 included in the fourth hand unit pair 34 as a fourth hand pair 304; the pair of hands 351, 356 included in the fifth hand unit pair 35 as a fifth hand pair 305; and the pair of hands 361, 366 included in the sixth hand unit pair 36 as a sixth hand pair 306. Further, a collection of these hand pairs 301 to 306 is referred to as a “blanket holding mechanism” and denoted by 300.

As shown in FIG. 2, out of six hand unit pairs 31 to 36, the hand unit pairs 32 to 35 in a middle part excluding those located on opposite end parts in the Y direction are so arranged that the hands 321, 326, 331, 336, 341, 346, 351 and 356 included in these hand unit pairs are distributed in a region corresponding to a plane size of the substrate SB. On the other hand, the hand unit pairs 31, 36 located on the opposite end parts in the Y direction are so arranged that the hands 311, 316, 361 and 366 included in these hand unit pairs are located at such positions as to come into contact with the lower surfaces of the vicinities of end parts of the blanket BL in the Y direction.

Further, the alignment stage 30 is supported by a plurality of alignment mechanisms 37 mounted on the base unit 11. The alignment mechanism 37 is a movable mechanism formed of, for example, a cross roller bearing. The plurality of alignment mechanisms 37 operate in cooperation in response to a control signal from an alignment controller 95 of the control block 9, whereby the alignment stage 30 can be moved in the XY plane (horizontal plane) and within a predetermined range about the Z axis (vertical axis).

The alignment stage 30 further includes two alignment cameras 381, 382 attached to column members (not shown) erected from the base unit 11. The alignment cameras 381, 382 are arranged to face upward and image alignment marks formed in advance on the blanket BL. The alignment controller 95 detects the position of the blanket BL from imaging results of the alignment cameras 381, 382 and actuates the alignment mechanisms 37 if necessary, thereby adjusting the position of the blanket BL in the apparatus.

Further, the transfer roller block 5 is further provided on the base unit 11. The transfer roller block 5 includes a guide rail 51 fixed to the base unit 11 and extending in the Y direction and a roller unit 50 configured to be movable in the Y direction along the guide rail 51.

The roller unit 50 includes a transfer roller 501, a support frame 502, a support leg 503 and a base unit 504. The transfer roller 501 is a cylindrical roller member which extends in the X direction and whose axial direction is the X direction. The support frame 502 rotatably supports opposite end parts of the transfer roller 501 in the X direction. The support leg 503 supports the support frame 502 and extends downward from a substantially central part of the support frame 503 in the X direction. The base unit 504 supports the support frame 503, is engaged with the guide rail 51 and moves in the Y direction. A dimension of the support leg 503 in the X direction is smaller than a distance between the tips of the hands constituting each hand pair. Although not shown, the base unit 504 includes an elevation mechanism for elevating and lowering the support leg 503. By elevating and lowering the support leg 503, the transfer roller 501 supported thereon moves in the Z direction toward and away from the blanket BL held by the blanket holding mechanism 300. A movement of the base unit 504 in the Y direction along the guide rail 51 and the elevating and lowering movements of the support leg 503 by the base unit 504 are controlled by a roller driver 93 provided in the control block 9.

On the other hand, the substrate holding block 7 includes an upper stage 71 whose lower surface forms a holding plane having substantially the same plane size as the substrate SB, and a stage elevation mechanism 72 for elevating and lowering the upper stage 71 in the vertical direction (Z direction). Although not shown, at least ones of suction holes, suction grooves and suction pads as a mechanism for sucking and holding the substrate SB are provided on the lower surface of the upper stage 71, and a negative pressure supplied from a negative pressure supplier 92 provided in the control block 9 is applied to this suction mechanism via a control valve 921. Thus, the upper surface of the substrate SB can be sucked and held onto the lower surface of the upper stage 71.

The stage elevation mechanism 72 elevates and lowers the upper stage 71 in response to a control signal from an upper stage controller 91 of the control block 9. This causes the substrate SB held by the upper stage 71 to move between a proximate position where the substrate SB proximately faces the upper surface of the blanket BL held by the blanket holding mechanism 300 and a spaced position where the substrate SB is largely spaced upward from the blanket BL.

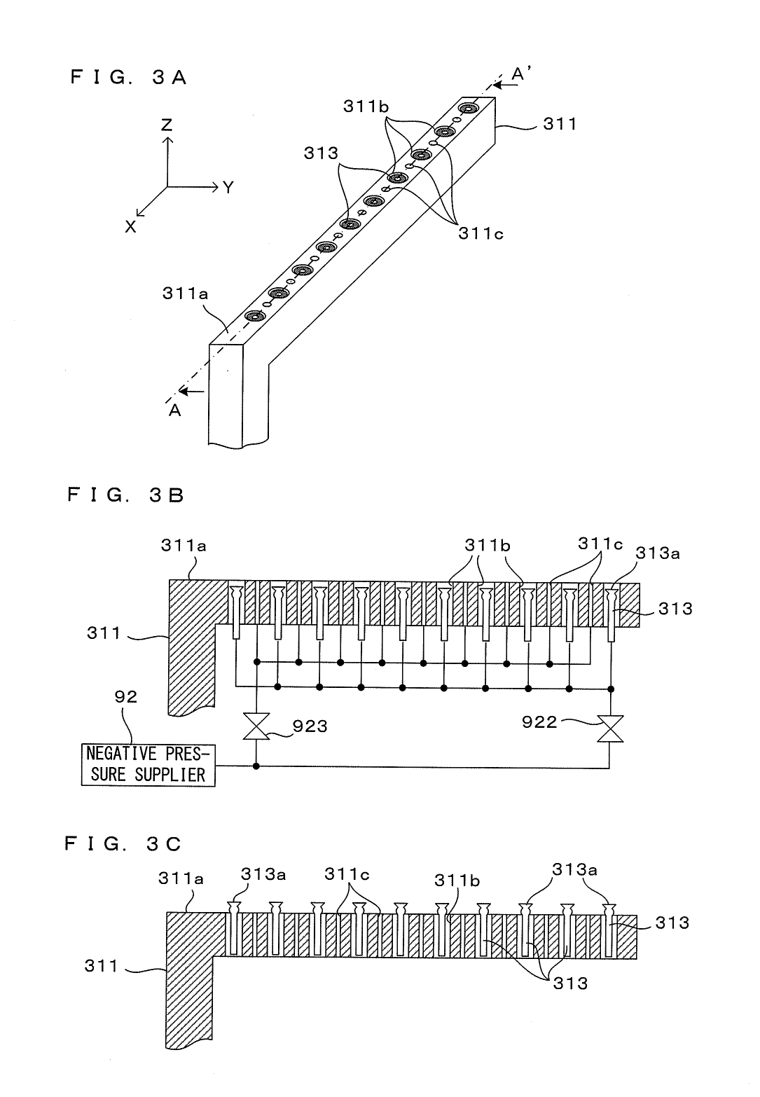

FIGS. 3A to 3C are enlarged views showing the structure of a hand tip in detail. Although the structure of the hand 311 is described as a representative here, each hand 311 to 366 has the same structure as described above. As shown in FIG. 3A, an upper surface 311a of a tip part of the hand 311 extending in the X direction is finished into a flat surface and serves as a contact surface to be brought into contact with the lower surface of the blanket BL, and two types of through holes having different opening diameters are perforated in this upper surface. More specifically, a plurality of first through holes 311b each of which has a relatively large opening diameter are provided at regular intervals in the X direction in the hand 311. A suction pad 313 whose upper end 313a is formed of an elastic material such as silicon rubber is inserted into each through hole 311b. Each suction pad 313 is connected to the negative pressure supplier 92 via a control valve 922 of the control block 9.

The respective suction pads 313 are integrally movable upward and downward by an unillustrated driving mechanism, and can be moved between a retracted position where the upper ends 313a of the suction pads 313 are retracted downward from the upper surface (contact surface) 311a of the hand 311 as shown in FIG. 3B and a suction position where the upper ends 313a of the suction pads 313 advance further upward than the upper surface 311a of the hand 311 as shown in FIG. 3C. When the suction pads 313 are positioned at the suction position, the blanket BL can be strongly sucked and held by the suction pads 313 by the negative pressure supplied from the negative pressure supplier 92.

On the other hand, other through holes 311c are through holes having a smaller opening diameter than that of the through holes 311b and are provided between the through holes 311b arranged at equal intervals in the X direction as described above. The through holes 311c are connected to the negative pressure supplier 92 via a control valve 923 of the control block 9. Thus, each through hole 311c functions as a suction hole for sucking the lower surface of the blanket BL by having the negative pressure supplied thereto. A force for sucking the blanket BL is weaker than the suction pad 313.

As just described, the through holes 311c and the suction pads 313 juxtaposed in the hand 311 function as the suction holes, and the negative pressure is independently supplied to the respective suction holes. Therefore, a suction force for sucking the blanket BL by the hand 311 can be set in a multistage manner.

Next, the operation of the transfer apparatus 1 configured as described above will be described. As described above, the transfer apparatus 1 brings the blanket BL carrying a pattern and the substrate SB, to which the pattern is to be transferred, into close contact and, then, transfers the pattern from the blanket BL to the substrate SB by detaching the blanket BL and the substrate SB. Although the transfer process is described below, an operation in patterning the blanket BL carrying a thin film formed of a pattern forming material by the plate is also basically the same.

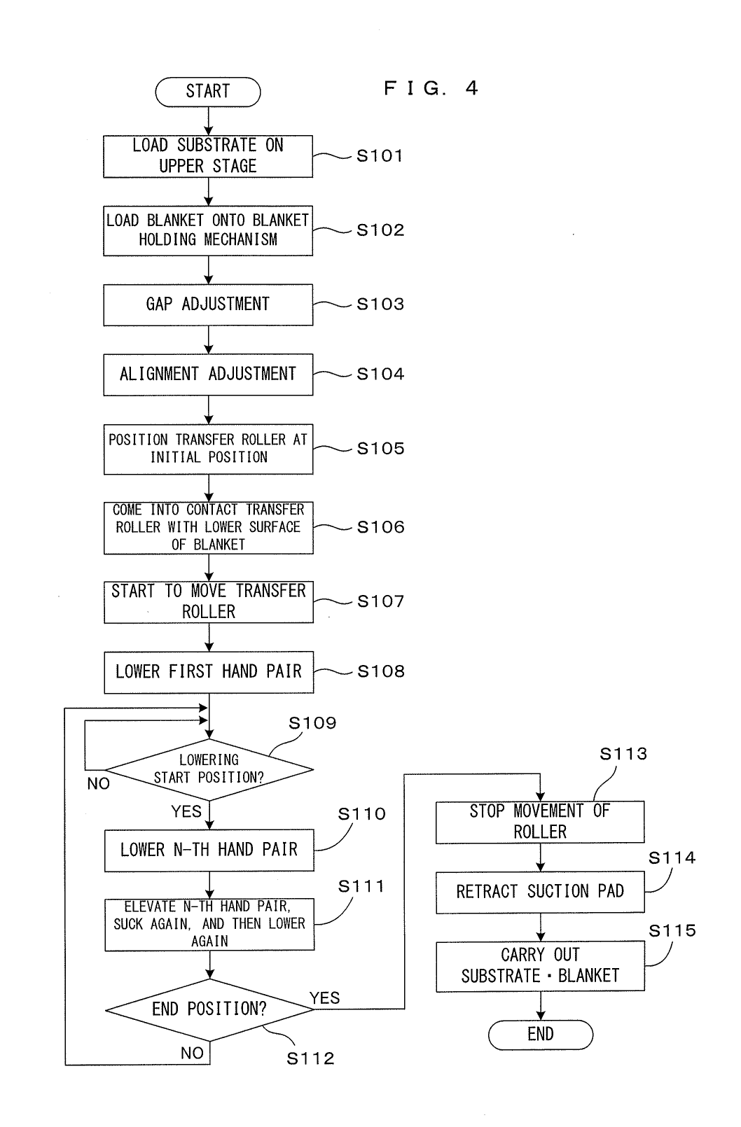

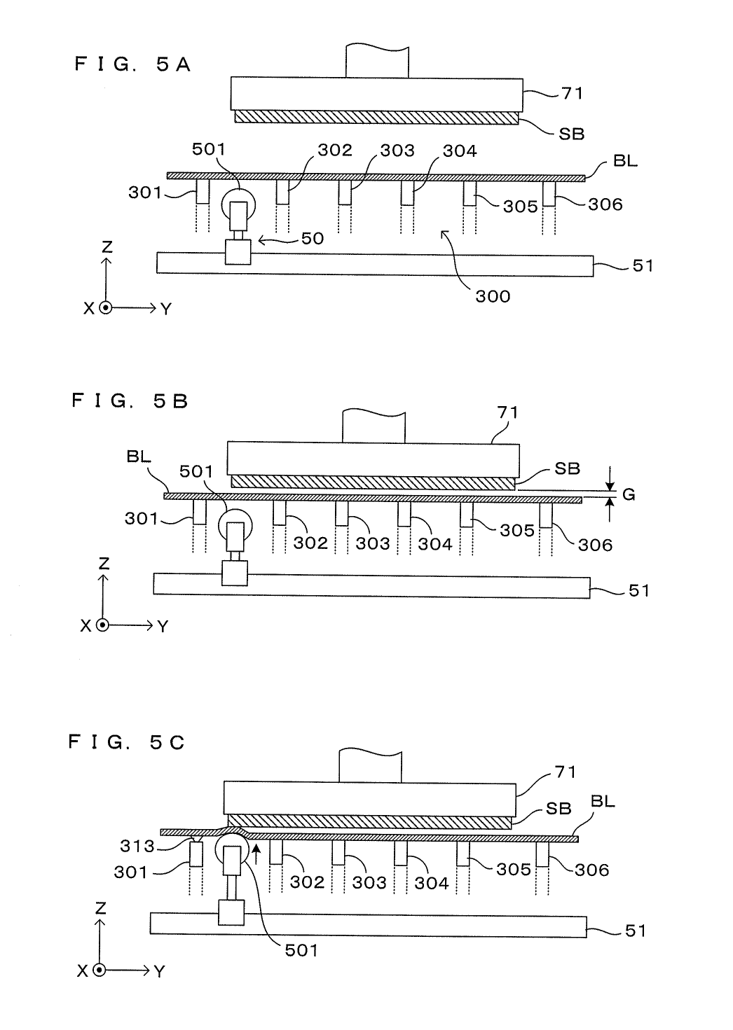

FIG. 4 is a flow chart showing the transfer process in this embodiment. FIGS. 5A to 5C, 6A to 6C and 7A to 7C are views diagrammatically showing a positional relationship of each component of the apparatus in each stage of the transfer process. Note that dimensions and intervals of the respective components are shown partly in an exaggerated manner to clearly show the positional relationship of the respective components in these figures, and these figures do not indicate actual dimensional relationships.

First, the substrate SB as a transfer medium, to which the pattern is to be transferred, is carried into the apparatus and loaded on the upper stage 71 with a transfer surface, to which the pattern is to be transferred, faced down (Step S101). Subsequently, the blanket BL carrying the pattern to be transferred to the substrate SB is loaded onto the blanket holding mechanism 300 with a carrying surface carrying the pattern faced up (Step S102). At this time, the suction pads 313 of each hand are located at the retracted position shown in FIG. 3B and the blanket BL is sucked and held by the negative pressure applied to the through holes 311c. Note that a loading sequence may be reversed. However, by carrying in the blanket BL carrying the pattern on the upper surface later, such trouble that the pattern on the blanket BL is damaged or a foreign matter falls down in loading the substrate SB can be avoided.

FIG. 5A shows a state after the substrate SB and the blanket BL are carried into the apparatus. While these are carried in, the upper stage 71 is positioned at a position largely spaced upward from the blanket holding mechanism 300, whereby the substrate SB can be carried in through a large space between the upper stage 71 and the blanket holding mechanism 300. On the other hand, when the blanket BL is carried in, the blanket BL can be carried in by a conveyance hand (not shown) for supporting the lower surface of the blanket BL by positioning each hand pair 301 to 306 at an elevated position. Further, the blanket BL can be held in the horizontal posture by setting each hand pair at the same height.

When the substrate SB and the blanket BL are carried in in this way, the upper stage 71 is lowered to cause the substrate SB and the blanket BL to proximately face each other with a predetermined gap therebetween (Step S103). For this purpose, it is preferable to measure thicknesses of the substrate SB and the blanket BL before the substrate SB and the blanket BL are carried in. As shown in FIG. 5B, a gap G between the substrate SB and the blanket BL adjusted at this time is, for example, about several hundreds of μm.

Subsequently, an alignment adjustment is performed to position the substrate SB and the blanket BL (Step S104). The alignment adjustment can be performed, for example, as follows. Alignment marks are formed in advance at two or more facing positions of the substrate SB and the blanket BL, and the alignment marks formed on the substrate SB and the blanket BL carried into the apparatus and proximately arranged are respectively imaged by the alignment cameras 381, 382. Since a relative positional relationship of the substrate SB and the blanket BL is grasped on the basis of imaging result including the alignment marks, the relative positions of the substrate SB and the blanket BL are adjusted by moving the alignment stage 30 by the alignment mechanisms 37 so that the grasped positional relationship matches a predetermined one.

To transfer the pattern formed on the blanket BL to a proper position of the substrate SB, it suffices to relatively position the substrate SB and the blanket BL, more specifically the pattern on the substrate SB and the pattern on the blanket BL. Further, by providing the alignment marks at two or more positions, imaging them by a plurality of alignment cameras and using the imaging result for the alignment adjustment, more accurate positioning is possible. Particularly, for a displacement in a rotating direction about the Z axis, it is effective to perform the alignment adjustment using, for example, two points largely spaced apart on the substrate SB, e.g. two alignment marks provided near diagonal corners.

Subsequently, the transfer roller 501 of the transfer roller block 5 is positioned at a predetermined initial position (Step S105). As shown in FIG. 5B, the initial position of the transfer roller 501 is a position spaced downward from the blanket BL in the vertical direction and right below a (−Y) side end part of the substrate SB between the first and second hand pairs 301, 302 in the Y direction. Note that the transfer roller 501 may be at this position from the beginning on or may be retracted from the blanket holding mechanism 300 when the blanket BL and the like are carried in and moved to the initial position after they are carried in.

Then, the transfer roller 501 moves upward to come into contact with the lower surface of the blanket BL (Step S106) and pushes up and brings the blanket BL into contact with the substrate SB as shown in FIG. 5C. A position on the lower surface of the blanket BL where the transfer roller 501 comes into contact at this time is referred to as a “contact start position”. When the pattern is carried on the blanket BL, it is held in close contact with the substrate SB. Subsequently, the transfer roller 501 starts moving in the (+Y) direction while being held in contact with the blanket BL (Step S107) and, thereafter, moves in the (+Y) direction at a constant speed. This causes a region where the blanket BL and the substrate SB are in contact to spread in the (+Y) direction.

A (+Y) side viewed from the transfer roller 501 is referred to as a front or downstream side in the moving direction of the transfer roller 501. Further, a (−Y) side viewed from the transfer roller 501 is referred to as a rear or upstream side in the moving direction of the transfer roller 501.

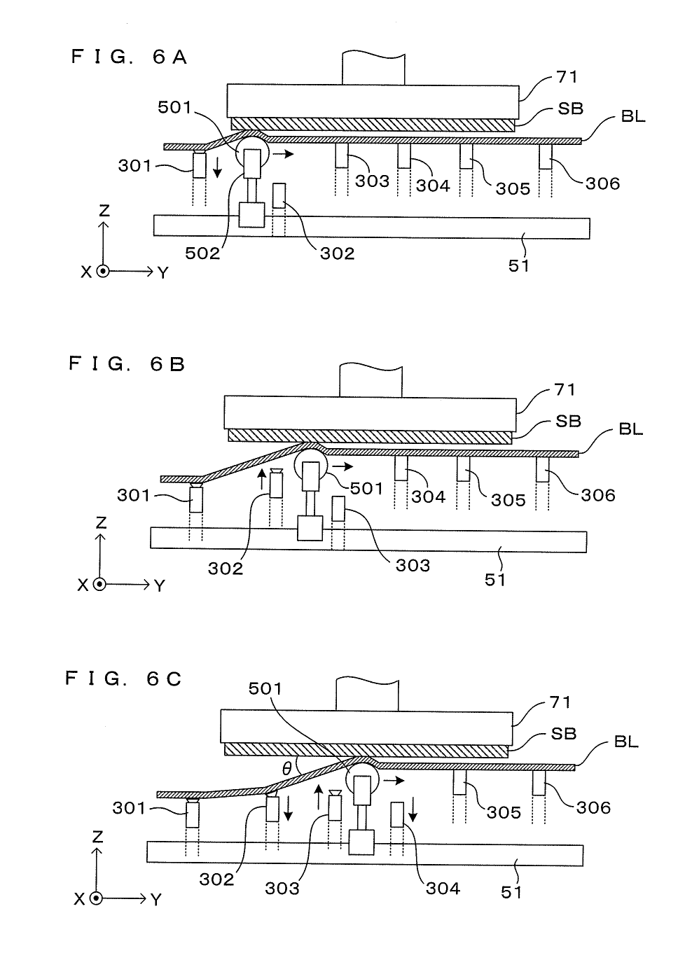

Subsequently, the suction pads of the first hand pair 301 located at the upstream side of the transfer roller 501 are elevated to the suction position shown in FIG. 3C, the negative pressure from the negative pressure supplier 92 is supplied to start suction by the suction pads and the lowering of the first hand pair 301 is started (Step S108). By lowering the hand pair 301 while the blanket BL is strongly sucked by the suction pads, the (−Y) side end part of the blanket BL is pulled downward as shown in FIG. 6A. This causes the blanket BL to be gradually separated from the (−Y) side end part of the substrate SB, whereby the detachment of the two is started.

Thereafter, the transfer roller 501 moves in the (+Y) direction. In front of the transfer roller 501, the respective hand pairs 302 to 306 support the lower surface of the blanket BL and interfere with the movement of the transfer roller 501. To avoid this, the respective hand pairs are lowered in synchronization with the movement of the transfer roller 501 and retracted to the retracted position where they do not interfere with the transfer roller 501. Specifically, the following movements are made.

The position of the transfer roller 501 specifying a timing at which the lowering of the hand pair is started is determined in advance as a lowering start position in correspondence with each of the N^{th} hand pairs (N=2 to 5). This lowering start position means that the N^{th} hand pair can be retracted to the retracted position, where it does not interfere with the transfer roller 501, before the transfer roller 501 arrives if the lowering of the N^{th} hand pair is started when the transfer roller 501 moving in the (+Y) direction arrives at the lowering start position.

Each hand pair has a function of holding the blanket BL in the horizontal posture by coming into contact with the blanket BL from below and keeping the gap G between the blanket BL and the substrate SB constant. Accordingly, if the lowering timing of the hand pair is too early, the blanket BL is deflected and the gap varies. To avoid this, the lowering start position is preferably a position maximally close to the hand pair within such a range that the transfer roller 501 and the hand pair do not interfere.

When the transfer roller 501 arrives at the lowering start position set in this way (Step S109), the lowering of the N^{th} hand pair corresponding to this lowering start position is started (Step S110). The suction by the suction holes provided in this hand pair is released immediately before the lowering is started. This can prevent the blanket BL from being deflected, following the lowering of the hand pair. In the suction by suction pads using an elastic member, there is a time delay until the suction is completely released after the supply of the negative pressure is stopped. This may lead to a possibility that the hand pair is lowered while sucking the blanket BL. However, this problem is avoided by the suction by the suction holes.

FIG. 6A shows a state where the second hand pair 302 is lowered to the retracted position. The retracted position is such a Z-direction position of the hands that the upper surfaces of the hands are lower than the lower surface of the support frame 502 for the transfer roller 501. Since the hands 321, 326 constituting the second hand pair 302 are so arranged that the tips thereof are spaced apart in the X direction, the support leg 503 for the transfer roller 501 can move through a clearance between the hands. The transfer roller 501 and the support frame 502 therefor pass above the hands. Thus, the interference of the transfer roller 502 and the second hand pair 302 is avoided.

By retracting the second hand pair 302 in this way, the transfer roller 501 can move further in the (+Y) direction. After the passage of the transfer roller 501, the second hand pair 302 is elevated again to come into contact with the lower surface of the blanket BL (Step S111). Together with the elevation, the suction pads of the hands 321, 326 of the second hand pair 302 advance to the suction position and the supply of the negative pressure from the negative pressure supplier 92 is started. In this way, the second hand pair 302 that has come into contact with the lower surface of the blanket BL again more strongly sucks the blanket BL by the suction pads than before the separation. After the suction by the suction pads is started, the second hand pair 302 is lowered again. This causes the blanket BL to be further pulled downward at the upstream side of the transfer roller 501, whereby the detachment from the substrate SB further progresses.

The same holds true for the hand pairs arranged at a more downstream side. Specifically, processings of Steps S109 to S111 are repeated until the transfer roller 501 arrives at an end position set farther on the (+Y) side than the (+Y) side end part of the substrate SB (Step S112). That is, each hand pair 303 to 305 is separated from the lower surface of the blanket BL and lowered to the retracted position at a timing at which the transfer roller 501 approaches the lowering start position set in correspondence with this hand pair. After being elevated again and sucking the blanket BL after the passage of the transfer roller 501, the hand pair moves downward again. The lowered hand pair arrives at a position sufficiently spaced downward from the substrate SB and may remain at that position after the detachment of the blanket BL by the hand pair located at the more downstream side is started.

FIG. 6B shows a state where the second hand pair 302 is elevated toward the blanket BL after the passage of the transfer roller 501, whereas the third hand pair 303 is lowered to the retracted position in response to the approach of the transfer roller 501. Further, FIG. 6C shows a state where the transfer roller 501 passes through the position of the third hand pair 303 and the third hand pair 303 is elevated toward the blanket BL, whereas the lowering of the fourth hand pair 304 located in front of the transfer roller 501 to the retracted position is started.

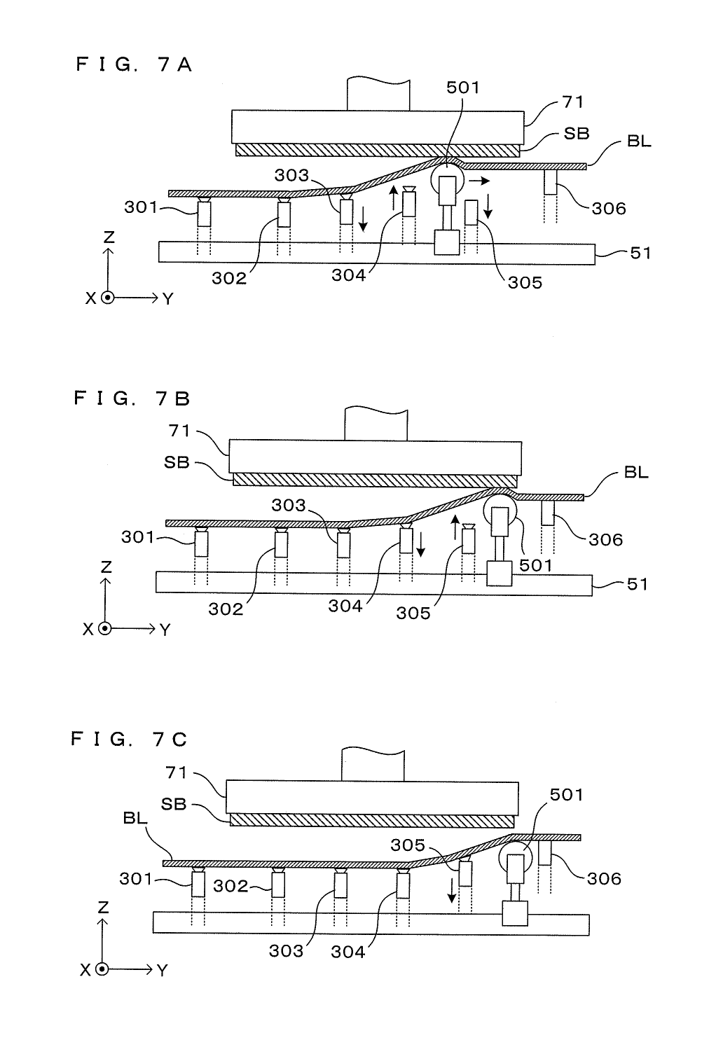

FIG. 7A shows a state where the fourth hand pair 304 is elevated toward the blanket BL after the passage of the transfer roller 501, whereas the fifth hand pair 305 is lowered toward the retracted position and the third hand pair 303 is lowered while sucking the blanket BL. Further, FIG. 7B shows a state where the transfer roller 501 passes through the position of the fifth hand pair 305 and arrives at the vicinity of the (+Y) side end part of the substrate SB. In this state, the transfer of the pattern from the blanket BL to the substrate SB is almost finished.

When the transfer roller 501 arrives at the (+Y) side end part of the substrate SB or an end position farther on the (+Y) side than the (+Y) side end part as shown in FIG. 7C, the contact and detachment of the blanket BL have been completed for the entire substrate SB. To maintain the posture of the blanket BL until the transfer roller 501 arrives at the (+Y) side end part of the substrate SB, the sixth hand pair 306 for supporting the blanket BL farther on the (+Y) side than the (+Y) side end part of the substrate SB is necessary.

When the transfer roller 501 arrives at the end position (Step S112), the movement of the transfer roller 501 is stopped (Step S113) and the transfer roller 501 moves downward to be separated from the blanket BL. Here, a position of the lower surface of the blanket BL where the transfer roller 501 is in contact at last is referred to as a “contact end position”. Further, the respective hand pairs 301 to 306 are positioned at the same height.

At this point of time, the blanket BL is completely separated from the substrate SB and supported by the respective hand pairs 301 to 306 of the blanket holding mechanism 300. When the detachment is finished, the suction by the suction pads of the hand pairs is released and the suction pads are retracted to the retracted position (Step S114). Then, the upper stage 71 is separated upward and then the substrate SB and the blanket BL are respectively carried out the apparatus 1 (Step S115), whereby the transfer process is completed.

Movements of each hand pair in the transfer process viewed from the transfer roller 501 are as follows. At the front side in the moving direction of the transfer roller 501, the foremost hand pair, i.e. the hand pair located at the most upstream side is lowered when the transfer roller 501 approaches to be at a predetermined distance from the hand pair, thereby creating a movement path for the transfer roller 501. On the other hand, at the rear side of the transfer roller 501, i.e. at the upstream side in the moving direction, the hand pair lowered to the retracted position is elevated to come into contact with the blanket BL again, and sucks and pulls down the blanket BL, whereby the blanket BL is detached from the substrate SB.

In this way, the hand pairs are successively lowered at the front side (downstream side) in the moving direction of the transfer roller 501 to ensure the movement path for the transfer roller 501 as the transfer roller 501 moves. Further, at a contact position where the transfer roller 501 is in contact with the blanket BL, the pattern carried on the upper surface of the blanket BL is pressed against the substrate SB and transferred to the substrate SB. On the other hand, at the rear side (upstream side) in the moving direction of the transfer roller 501, the blanket BL held in close contact with the substrate SB is pulled downward while being sucked and held by the hand pair, thereby being detached from the substrate SB. By vertically moving the respective hand pairs in synchronization with the movement of the transfer roller 501 at the upstream and downstream sides of the transfer roller 501 in this way, the pattern transfer from the blanket BL to the substrate SB and the detachment of the blanket BL from the substrate SB can simultaneously progress in this embodiment.

During this time, at the downstream side in the moving direction of the transfer roller 501, the hand pairs support the blanket BL immediately until the transfer roller 501 arrives, whereby the gap between the blanket BL and the substrate SB can be properly maintained. This can prevent the transfer position of the pattern from being displaced by a change in the push-up amount of the blanket BL due to a gap variation. Specifically, the transfer apparatus 1 can satisfactorily transfer the pattern from the blanket BL to the substrate SB without damaging the pattern.

Further, at the upstream side in the moving direction of the transfer roller 501, the hand pairs are successively lowered from the one located at the most upstream side while sucking and holding the blanket BL, whereby the blanket BL is detached from the substrate SB. The detachment progresses in one direction from the upstream side to the downstream side of the blanket BL and a detachment progress speed is controlled by the lowering speed of the hand pairs. Thus, the substrate SB and the blanket BL can be satisfactorily detached and the damage of the pattern due to a variation of the detachment progress speed is prevented. Therefore, the transfer apparatus 1 can satisfactorily detach the blanket BL and the substrate SB after the pattern transfer without damaging the pattern.

Particularly, the hand pair closest to the transfer roller 501 at the upstream side of the transfer roller 501 detaches the blanket BL in accordance with the movement of the transfer roller 501 while sucking the blanket BL. Therefore, an angle formed between the substrate SB and the blanket BL (e.g. angle θ in FIG. 6C) on an upstream end part of a contact region where the transfer roller 501 and the blanket BL are in contact, i.e. on a boundary between an already detached region and an undetached region can be substantially constant. This enables the detachment to progress while a detachment force for pulling the two apart is kept substantially constant. This leads to the prevention of a local stress concentration on the pattern due to a variation of the detachment force, wherefore the detachment can be more satisfactorily performed.

Specifically, in this embodiment, the hands 311, 316, 321, 326, 331, 336, 341, 346, 351, 356, 361 and 366 have both a function of maintaining the posture of the blanket BL and the gap between the blanket BL and the substrate SB at the front side (downstream side) in the moving direction of the transfer roller 501 and a function as a detacher for detaching the blanket BL from the substrate SB at the rear side (upstream side) in the moving direction of the transfer roller 501. Further, the transfer roller 501 has both a function as an original transfer roller for transferring the pattern by pushing the blanket BL against the substrate SB and a function as a detachment control roller for controlling the progress of the detachment of the substrate SB and the blanket BL performed at the upstream side in the moving direction thereof.

In this embodiment, the pattern transfer from the blanket BL to the substrate SB and the detachment of the two after the transfer are performed in parallel. This enables a series of pattern forming processes from the transfer to the detachment to be successively and efficiently finished in a short time and the throughput of pattern formation to be improved. Further, the transfer and the detachment can be performed by the integrated apparatus, and the footprint of the apparatus can be drastically reduced as compared with conventional apparatuses for independently performing these two processes. Particularly, since each of the hands and the transfer roller has both the function for the transfer and the function for the detachment, the two functions can be realized by the apparatus of a size comparable to the apparatus for performing only one function of the transfer or the detachment.

As described above, in this embodiment, the blanket BL corresponds to a “carrier” of the invention, the upper surface of the blanket BL for carrying the pattern as the “transfer object” corresponds to a “carrying surface”, and the lower surface corresponds to an “other surface”. The substrate SB corresponds to a “transfer medium” of the invention, and the lower surface thereof corresponds to a “transfer surface”. Further, in this embodiment, the X direction corresponds to a “first direction” of the invention, whereas the Y direction corresponds to a “second direction”.

Further, in the above embodiment, each hand pair 301 to 306 functions as a “holder” of the invention, and the blanket holding mechanism 300 as a collection of these corresponds to a “carrier holder” of the invention. Further, the elevation mechanisms 312, 317, 322, 327, 332, 337, 342, 347, 352, 357, 362 and 367 and the hand elevation controller 94 integrally function as a “holder driving mechanism” of the invention. The upper surface 311a of the hand 311 corresponds to a “contact surface” of the invention, the through hole 311b functions as a “recess” of the invention, and the through hole 311c and the suction pad 313 function as a “suction unit” of the invention. Further, in the above embodiment, the transfer roller 501 functions as a “roller member” of the invention.

Further, in the above embodiment, Step S102 of FIG. 4 corresponds to a “first step” of the invention, and Steps S101, S103 correspond to a “second step” of the invention. Further, Step S106 corresponds to a “third step” of the invention. Further, Steps S107, S108 and S110 correspond to a “fourth step” of the invention, whereas Step S111 corresponds to a “fifth step” of the invention. Furthermore, Step 104 corresponds to a “sixth step” of the invention.

Note that the invention is not limited to the above embodiment and various changes other than the above ones can be made without departing from the gist thereof. For example, in the above embodiment, a plurality of hand unit pairs each composed of a pair of elevation hand units juxtaposed in the X direction are juxtaposed in the Y direction. This configuration is adopted due to necessity to allow the passage of the support leg 503 for the transfer roller 501, but there is no limitation to such a configuration. For example, the following configuration may be adopted.

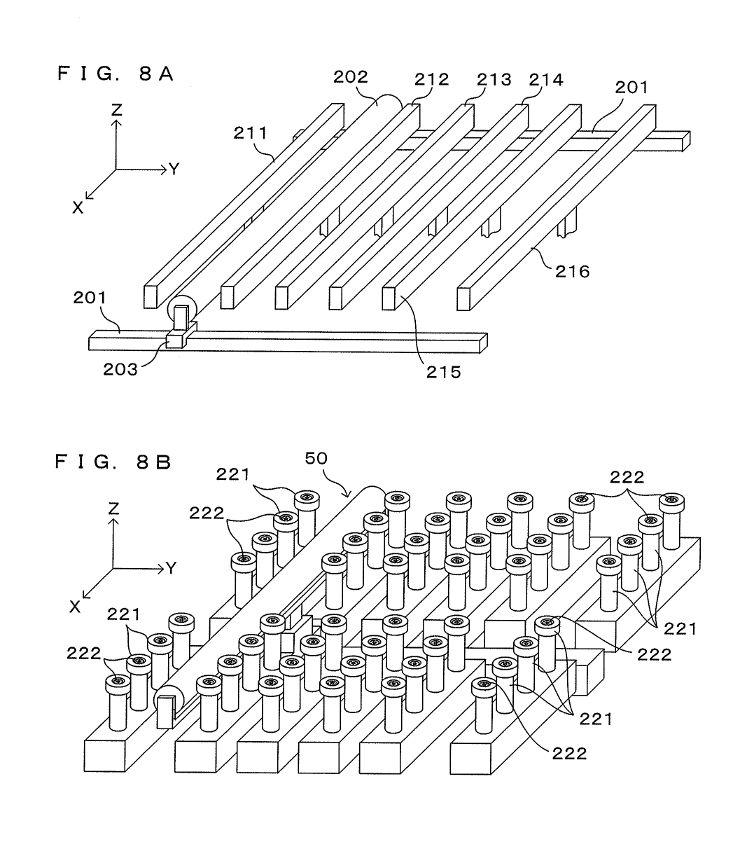

FIGS. 8A and 8B are views showing other configuration examples of the transfer apparatus according to the present invention. In an example shown in FIG. 8A, two guide rails 201, 201 extending in the Y direction are provided at different positions in the X direction, and supporting members 203 for supporting each of opposite end parts of a transfer roller 202 are respectively engaged with the guide rails 201. By such a mechanism, the transfer roller 202 is movable in the Y direction. In this case, a space for allowing the passage of a support leg for a transfer roller is not necessary between hands. Accordingly, the blanket BL can be supported by hands 211 to 216 continuously extending in the X direction. By elevating and lowering a plurality of hands 211 to 216 arranged in the Y direction in accordance with the movement of the transfer roller 202, the transfer process can be performed as in the above embodiment.

Further, an example of FIG. 8B includes a roller unit 50 similar to that of the above embodiment, but the blanket BL is supported by a plurality of supporting members 221 juxtaposed in the X direction instead of the hands extending in the X direction. Each supporting member 221 includes a suction pad 222 in a recess provided on the upper surface. By successively elevating and lowering the respective supporting members 221 juxtaposed in the Y direction while maintaining a plurality of supporting members 221 arranged in the X direction at the same height, the transfer process can be performed as in the above embodiment. As just described, the holder for holding the blanket BL can be realized not only by a member extending in the X direction, but also a plurality of members arranged in the X direction.

For example, although the alignment adjustment is performed before the blanket BL is pushed up toward the substrate SB in the above embodiment, this process can be omitted. Specifically, the alignment adjustment may be omitted if sufficient position accuracy can be ensured or high position accuracy is not required in carrying in the substrate SB and the blanket BL. Further, in the case of using this apparatus in the patterning step, there is no displacement between the pattern to be transferred to the substrate SB and the alignment marks if the alignment marks formed on the blanket BL are made of the same material as the pattern and patterned simultaneously with the pattern. Thus, the plate and the blanket need not be accurately positioned in the patterning step and the alignment adjustment can be omitted.

For example, although the blanket BL is carried out together with the substrate SB after the detachment in the above embodiment, there are cases where it is effective to leave the blanket BL in the apparatus. Specifically, if the patterning step of patterning the pattern forming material on the blanket BL by the plate and the transferring step of transferring the patterned pattern from the blanket BL to the substrate SB are both performed in the transfer apparatus 1, the blanket BL needs not be carried out during this time if the plate is carried out with the patterned blanket BL left behind and the substrate SB is subsequently carried in for the transfer.

For example, as shown in FIG. 6B, before the hand pair once separated from the blanket comes into contact again, the lowering of the hand pair downstream of and adjacent to the former hand pair is started in the above embodiment. On the other hand, instead of this, it is also considered to start the lowering of the succeeding hand pair after the once lowered hand pair comes into contact with the blanket again. An appropriate mode should be selected mainly according to mechanism restrictions of the apparatus such as the elevating and lowering speeds, stroke and arrangement pitch of the hands and the size and moving speed of the transfer roller. The invention is not limited to any one of these modes.

For example, although a total of six hand pairs are provided as the holders of the invention in the above embodiment, the number of the holders is not limited to this and can be appropriately increased and decreased according to the size and rigidity of the blanket (carrier). However, it is preferable to provide at least one holder at each of upstream and downstream sides of a movement range of the transfer roller to hold the postures of opposite end parts of the carrier with which the transfer roller does not come into contact. Further, it is preferable to provide at least two holders within the movement range of the transfer roller to maintain the posture of the blanket during the movement of the transfer roller and smoothly detach the blanket from the substrate. Of course, finer posture control and detachment control are possible by increasing the number of the holders, but the arrangement pitch of the holders becomes smaller. Thus, it becomes necessary to simultaneously lower several holders, leading to a possibility of diminishing the meaning of increasing the number and naturally complicating the control.

For example, in the above embodiment, the through holes 311c that function as the suction holes for sucking and holding the carried-in blanket BL with a relatively weak suction force are provided in the hand 311 and the like. Instead of this, the through holes 311b may be caused to function as suction holes, for example, by applying the negative pressure in a state where the suction pads 313 are retracted to the retracted position in the through holes 311b and separated from the lower surface of the blanket BL.

Further, although the control block 9 of the above embodiment includes the negative pressure supplier 92, it may not include the negative pressure supplier if a negative pressure supplied from the outside such as factory power usage is usable.

The present invention can be applied to a technology for transferring a transfer object from a carrier carrying the transfer object to a transfer medium. Particularly, the transfer of the transfer object performed by detaching the carrier and the transfer medium after bringing the carrier and the transfer medium into close contact can be performed in good quality and in a short time, and the apparatus can be miniaturized. Note that the transfer object is not limited to a pattern and may be a thin film such as a protective film or a resist film.

In these inventions, the carrier carrying the transfer object and the transfer medium to which the transfer object is to be transferred are arranged to proximately face each other, the transfer object is brought into contact with the transfer medium by partially displacing the carrier toward the transfer medium by the roller member and, in that state, the roller member moves along the carrier. In this way, the transfer object carried on the carrier can be entirely held in close contact with the transfer medium.

The carrier is held by the plurality of holders and the holders are sequentially moved to the retracted position in accordance with the movement of the roller member, thereby avoiding the interference of the holders held in contact with the other surface of the carrier and the roller member moving in the second direction while being held in contact with the other surface of the carrier.

On the other hand, at an upstream side of the roller member in the moving direction of the roller member, i.e. at a side where the carrier and the transfer medium are held in close contact via the transfer object by the passage of the roller member, the holder brought into contact again is moved in the separating direction while holding the carrier. Accordingly, the carrier is moved in the direction away from the transfer medium, whereby the two are detached. By separating the carrier from the transfer medium while holding the roller member in contact with the carrier, the progress of the detachment can be controlled.

As just described, the holders in the invention have both a function of maintaining the posture of the carrier before the transfer object comes into contact with the transfer medium and a function of separating the carrier from the transfer medium after the contact. On the other hand, the roller member has both a function of bringing the transfer object into contact with the transfer medium and a function of controlling the progress of the detachment. According to the invention having such a configuration, the transfer of the transfer object from the carrier to the transfer medium and the detachment of the carrier and the transfer medium after the transfer can be successively and efficiently performed by the integrated apparatus.

In these inventions, for example, the most upstream one of the holders held in contact with the other surface at a downstream side of the roller member in the second direction may be separated from the carrier and moved to the retracted position and, after the passage of the roller member, brought into contact with the other surface again, whereas the holders held in contact with the other surface at an upstream side of the roller member in the second direction may be successively moved in the direction away from the carrier from the upstream side while continuing to suck the other surface.

The holders at the downstream side in the roller moving direction (second direction) may be moved to the retracted position for moving the roller, but only the most upstream one of the above holders is moved in accordance with a movement of the roller member. Therefore, the posture of the carrier before being held in contact with the roller member is maintained. Thus, the transfer object can be prevented from being displaced between the carrier and the transfer medium before coming into contact with the transfer medium.

For example, the roller member may come into contact with the carrier at a contact start position downstream of an upstream side end part of the other surface in the second direction and move to a contact end position upstream of a downstream side end part of the other surface in the second direction and downstream of the contact start position, the plurality of holders may be provided between the contact start position and the contact end position, and at least one holder may be provided on each of a side upstream of the contact start position and a side downstream of the contact end position in the second direction.

The holders are necessary in a movement range of the roller member, i.e. between the contact start position and the contact end position to separate the carrier from the transfer medium after the contact while maintaining the posture of the carrier before the contact with the transfer medium via the transfer object. On the other hand, it is preferable to arrange at least one holder at each of the upstream and downstream sides of the movement range of the roller member to hold the posture of the carrier even outside the movement range of the roller member and reliably detach the carrier from the transfer medium.

For example, each holder may release suction before the separation from the carrier and resume suction after the re-contact. By separating the holder after the suction is released, a movement of the carrier following a separating movement of the holder is avoided. In this case, the carrier may be sucked with a stronger suction force after the re-contact than before the suction is released. It suffices to be able to maintain the posture of the carrier before the carrier comes into contact with the transfer medium via the transfer object. On the other hand, since a strong sucking and holding force is necessary to separate the carrier from the transfer medium, the suction force after the re-contact is preferably set larger than that before the suction is released.

To enable this, for example, the holder may include a contact surface which extends in the first direction and comes into contact with the other surface, the contact surface may include a recess for arranging a suction pad as the suction unit, and the suction pad may be movable back and forth between a retracted position where the suction pad is retracted into the recess from the contact surface and a suction position where the suction pad advances to the same plane as the contact surface or further than the contact surface. By bringing the suction pad advanced to the suction position into contact with the other surface of the carrier, the carrier can be sucked and held with a relatively strong force. On the other hand, by retracting the suction pad to the retracted position away from the carrier, a partial deformation of the carrier due to the strong suction force is avoided.

For example, each holder may include a plurality of suction units along the first direction. Further, the suction unit may have a long and narrow shape whose longitudinal direction is the first direction. In these configurations, the deflection of the carrier in the first direction can be prevented by dispersing the suction force in separating the carrier from the transfer medium in the first direction.

For example, the detachment at the upstream side of the roller member may be performed in parallel with the movement of the roller member. Specifically, in the transfer method according to the invention, the fifth step may be performed during the execution of the fourth step. In such a configuration, the transfer object is brought into contact with the transfer medium at the downstream side of the roller member, whereas the detachment of the carrier from the transfer medium is performed in parallel with this at the upstream side. Thus, the contact of the carrier and the transfer medium and the detachment of these can be successively performed in a short time. Further, a progress control of the detachment by the roller member most effectively functions.

Further, after the carrier and the transfer medium are arranged to face each other, the plurality of holders may be integrally moved in a direction parallel to the carrying surface to position the carrier and the transfer medium. In such a configuration, transfer position accuracy of the transfer object to the transfer medium can be enhanced and the transfer object can be transferred to a proper position of the transfer medium.

According to the present invention, the transfer object carried on the carrier is brought into contact with the transfer medium by bringing the roller member into contact with the carrier while maintaining the posture of the carrier by the holders, and the holders separate the carrier from the transfer medium for the detachment after the passage of the roller member. Thus, the transfer of the transfer object from the carrier to the transfer medium and the detachment of the carrier and the transfer medium after the transfer can be successively and efficiently by the integrated apparatus.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A transfer apparatus, the apparatus comprising:
a carrier holder that includes a plurality of holders and is configured to hold a plate-like carrier having a carrying surface, on which a transfer object is carried, by the holders respectively coming into contact with the other surface of the carrier opposite to the carrying surface;
a holder driving mechanism that individually moves the holders in directions toward and away from the other surface;
a transfer medium holder that holds a transfer medium having a transfer surface, to which the transfer object is to be transferred, such that the transfer surface proximately faces the carrying surface; and
a roller member that has a roller shape whose axial direction is a first direction parallel to the carrying surface and is configured to move in a second direction parallel to the carrying surface and perpendicular to the first direction while bringing the transfer object into contact with the transfer surface by coming into contact with the other surface and partially displacing the carrier toward the transfer medium, wherein
the holders, each of which includes a suction unit for sucking the other surface, are arranged along the second direction, and
each of the holders is sequentially separated from the carrier in accordance with a movement of the roller member, moves to a retracted position where the holder does not interfere with the roller member, comes into contact with the other surface of the carrier again after the passage of the roller member, and moves in the direction away from the carrier while sucking the carrier by the suction unit.

2. The transfer apparatus according to claim 1, wherein
the most upstream one of the holders held in contact with the other surface at a downstream side of the roller member in the second direction is separated from the carrier and moved to the retracted position and, after the passage of the roller member, brought into contact with the other surface again, whereas the holders held in contact with the other surface at an upstream side of the roller member in the second direction is successively moved in the direction away from the carrier from the upstream side while continuing to suck the other surface.

3. The transfer apparatus according to claim 1, wherein
the roller member comes into contact with the carrier at a contact start position downstream of an upstream side end part of the other surface in the second direction and moves to a contact end position upstream of a downstream side end part of the other surface in the second direction and downstream of the contact start position,
the holders are provided between the contact start position and the contact end position, and
at least one holder is provided on each of a side upstream of the contact start position and a side downstream of the contact end position in the second direction.

4. The transfer apparatus according to claim 1, wherein
each holder releases suction with the suction unit before the separation from the carrier and resumes suction after the re-contact.

5. The transfer apparatus according to claim 4, wherein
the suction unit sucks the carrier with a stronger suction force after the re-contact than before the suction is released.

6. The transfer apparatus according to claim 5, wherein
each holder includes a contact surface which extends in the first direction and comes into contact with the other surface,
the contact surface includes a recess for arranging a suction pad as the suction unit, and
the suction pad is movable back and forth between a retracted position where the suction pad is retracted into the recess from the contact surface and a suction position where the suction pad advances to the same plane as the contact surface or further than the contact surface.

7. The transfer apparatus according to claim 1, wherein
the number of suction units in each holder is more than one, and in each holder the suction units are located along the first direction.

8. A transfer method, the method comprising:
a first step of holding a plate-like carrier having a carrying surface, on which a transfer object is carried, by respectively bringing a plurality of holders into contact with the other surface of the carrier opposite to the carrying surface;
a second step of holding a transfer medium having a transfer surface, to which the transfer object is to be transferred, such that the transfer surface proximately faces the carrying surface;
a third step of bringing the transfer object into contact with the transfer surface by bringing a roller member having a roller shape whose axial direction is a first direction parallel to the carrying surface into contact with the other surface to partially displace the carrier toward the transfer medium;
a fourth step of moving the roller member in a second direction parallel to the carrying surface and perpendicular to the first direction while bringing the roller member into contact with the other surface, sequentially separating the holders from the carrier and moving the holders to a retracted position where the holders do not interfere with the roller member in accordance with a movement of the roller member, and bringing the holders into contact with the other surface of the carrier again after the passage of the roller member; and
a fifth step of moving the holder in the direction away from the carrier while holding the carrier by the holders held in contact with the other surface.

9. The transfer method according to claim 8, wherein
in the fourth step, the most upstream one of the holders held in contact with the other surface at a downstream side of the roller member in the second direction is separated from the carrier and moved to the retracted position and, after the passage of the roller member, brought into contact with the other surface again, whereas the holders held in contact with the other surface at an upstream side of the roller member in the second direction is successively moved in the direction away from the carrier from the upstream side while continuing to suck the other surface.

10. The transfer method according to claim 8, wherein
the fifth step is performed during the execution of the fourth step.

11. The transfer method according to claim 8, wherein
each holder sucks and holds on the other surface, and in the fourth step the suction with the holder is released before the separation of the holder from the carrier and resumed after the re-contact.

12. The transfer method according to claim 11, wherein
each holder sucks the carrier with a stronger suction force after the re-contact than before the suction is released.

13. The transfer method according to claim 8, further comprising a sixth step of integrally moving the holders in a direction parallel to the carrying surface to position the carrier and the transfer medium, wherein
the sixth step is performed between the second step and the third step.
